(19) United States
(12) Patent Application Publication
(10) Pub. No.: US 2015/0137738 A1
(43) Pub. Date: May 21, 2015

(54) DESK STORAGE DEVICE WITH POWER CHARGING FUNCTION

(71) Applicant: Chung Chiao Holding Corp., Taipei City (TW)

(72) Inventor: Shih-Hsing CHIEN, Taoyuan County (TW)

(73) Assignee: Chung Chiao Holding Corp., Taipei City (TW)

(21) Appl. No.: 14/083,957

(22) Filed: Nov. 19, 2013

(51) Int. Cl. H02J 7/00

(52) U.S. Cl. CPC H02J 7/0042; H02J 7/0021; H02J 7/0052
USPC 320/107

(57) ABSTRACT

A desk storage device includes a housing including an accommodation chamber, a front cover panel for controlling access to the accommodation chamber and a plurality of partition boards adjustably mounted in the accommodation chambers at selected elevations and defining an insertion slot between each two adjacent partition boards for storing one respective mobile electronic device, and a power module mounted in a bottom side in the accommodation chamber and including a control system and a system circuit board that includes electrical connectors for charging storage mobile electronic devices subject to the control of the control system and indicator lights controllable by the control system to indicate the charging status of each storage mobile electronic device.

### BACKGROUND OF THE INVENTION

1. Field of the Invention

The present invention relates to storage means for use in a desk or the like for storing mobile electronic devices, and more particularly to a desk storage device, which allows adjustment of the height of every insertion slot subject to the size of each mobile electronic device to be stored and, which is capable of charging all storage mobile electronic devices synchronously and allows storage mobile electronic devices to transmit electronic signals and data during charging.

2. Description of the Related Art

With fast development of electronic and multimedia technologies, advanced and sophisticated smart phone, tablet computer, PDA and many other mobile electronic devices have been continuously created and appeared on the market. These mobile electronic devices have the characteristics of small size, light weight and high mobility. With continuous creation of hardware and software functions, mobile electronic devices are widely used in our daily life for different purposes.

However, due to the characteristics of small size, light weight and high mobility, these mobile electronic devices can easily be damaged by impact. Protective cases are commercially available for protecting mobile electronic devices. However, these commercial protective cases are commonly designed for storing an individual mobile electronic device. Further, a school, organization or office may need to use a large number of tablet computers, notebook computers, PDAs or other mobile electronic devices to satisfy different requirements for information sorting or different software applications. After each use, these mobile electronic devices may be directly left on desks. The use of a large amount of mobile electronic devices brings inconvenience to the person in charge. Further, these mobile electronic devices can be easily stolen.

Further, putting mobile electronic devices in protective cases facilitates carrying and enhancing convenience and ease of use. However, conventional protective cases for mobile electronic device do not provide a charging function. When going to charge each storage mobile electronic device, the user must take the storage mobile electronic device out of the protective case and then electrically connect the mobile electronic device to an external power source by a power adapter or battery charger. Further, when a user wishes to update the educational software program or other application software program of multiple mobile electronic devices, the user must connect every mobile electronic device individually to a host computer or server and starts every mobile electronic device, and then control the host computer or server to update the software program. However, this individual mobile electronic device updating operation takes much time. It is quite inconvenient to connect and arrange the transmission cables of a large amount of mobile electronic devices.

### SUMMARY OF THE INVENTION

The present invention has been accomplished under the circumstances in view. It is the main object of the present invention to provide a desk storage device with power charging function, which is practical for storing different types of mobile electronic devices and charging storage mobile electronic devices and allowing storage mobile electronic devices to transmit electronic signals and data during charging.

To achieve this and other objects of the present invention, a desk storage device of the invention comprises a housing and a power module. The housing comprises an accommodation chamber, two sets of sliding members symmetrically defined at two opposite lateral sides and at different elevations within the accommodation chamber, a plurality of partition boards inserted into the sliding members and defining an insertion slot between each two adjacent partition boards, a face panel frame disposed at a front side of the accommodation chamber and defining an access opening at the center thereof and a plurality of plug holes and indicator mounting holes at one lateral side relative to the access opening, and a front cover panel adapted for closing and opening the access opening of the face panel frame. The power module is mounted in the accommodation chamber inside the housing, comprising a system circuit board and a control system electrically coupled with the system circuit board. The control system comprises a circuit layout for processing electronic signals. The system circuit board comprises a plurality of electrical connectors and a plurality of indicator lights respectively mounted in the plug holes and the indicator mounting holes. The electrical connectors are controllable by the control system to charge every mobile electronic device that is inserted into one respective the insertion slot and electrically connected to one respective the electrical connector by a respective transmission cable. The indicator lights are controllable by the control system to give off light and to flash subject to the charging status of each respective mobile electronic device that is connected to one respective the electrical connector.

Other advantages and features of the present invention will be fully understood by reference to the following specification in conjunction with the accompanying drawings, in which like reference signs denote like components of structure.

### BRIEF DESCRIPTION OF THE DRAWINGS

FIG. 1 is a top elevational view of a desk storage device in accordance with the present invention.

FIG. 2 is an exploded view of the desk storage device in accordance with the present invention.

FIG. 3 corresponds to FIG. 2 when viewed from another angle.

FIG. 4 is a schematic drawing illustrating adjustment of the positions of the partition boards in the housing of the desk storage device in accordance with the present invention.

FIG. 5 is an oblique front elevational view of the desk storage device in accordance with the present invention, illustrating the front cover panel opened through 90° angle.

FIG. 6 is a schematic elevational view of the present invention, illustrating an application status of the desk storage device.

FIG. 7 is a schematic front view of the present invention, illustrating another application status of the desk storage device.

### DETAILED DESCRIPTION OF THE PREFERRED EMBODIMENT

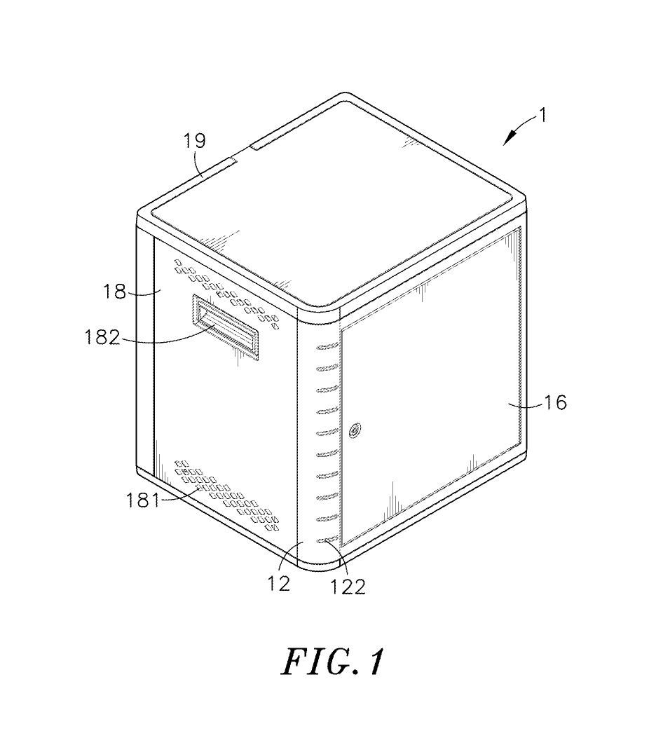

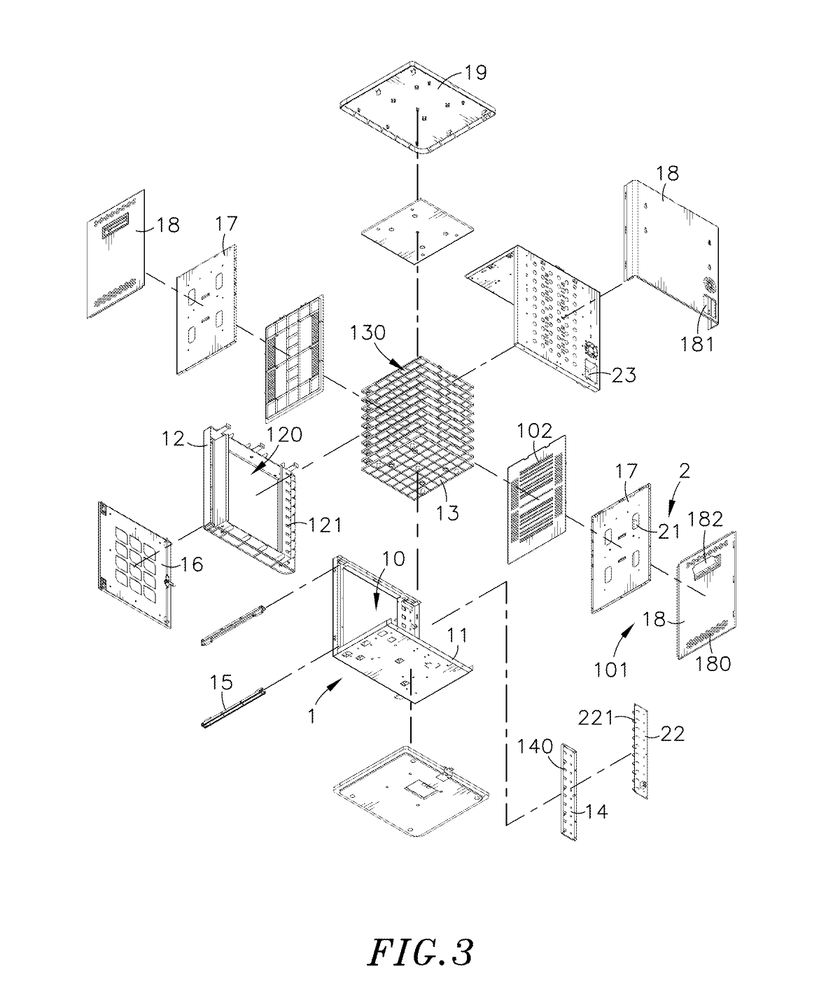

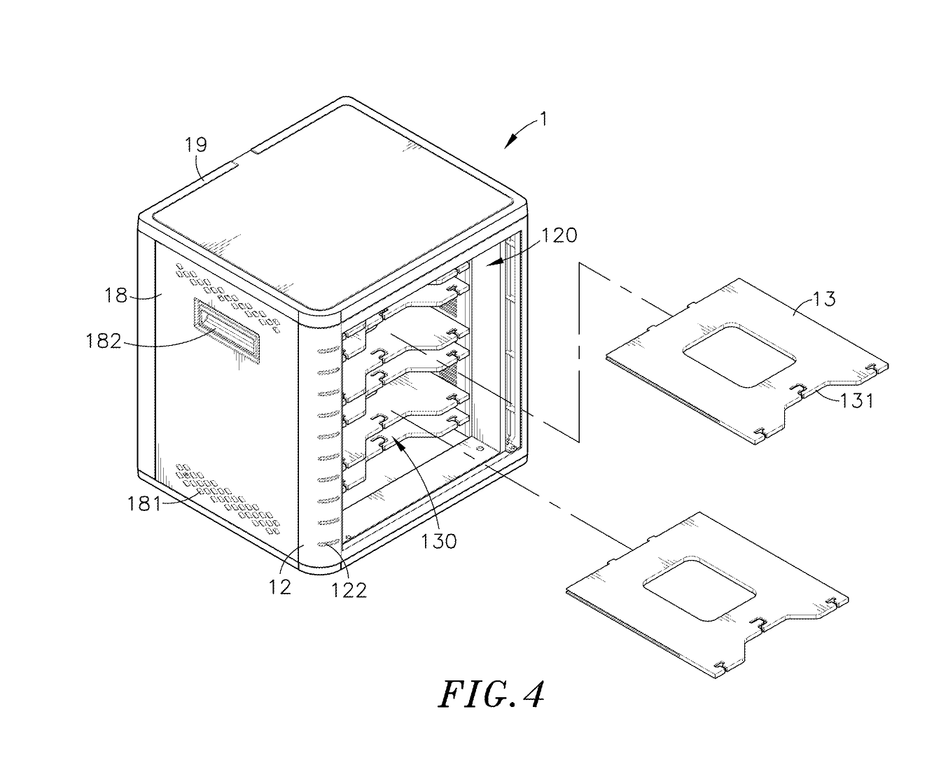

Referring to FIGS. 1-4, a desk storage device in accordance with the present invention is shown. The desk storage device comprises a housing 1, and a power module 2,

The housing 1 comprises a base frame 11, a face panel frame 12, which is mounted at a front side of the base frame 11 in vertical, comprising an access opening 120 disposed at the center and a plurality of plug holes 121 and indicator mounting holes 122 disposed at one lateral side thereof at different elevations, a plurality of, for example, three upright panels 17 respectively mounted at two opposite lateral sides and a back side of the base frame 11 in vertical, a peripheral cover panel 18 affixed to each upright panel 17, a top cover panel 19 fixedly mounted at the topmost edges of the upright panels 17, two sliding rails 15 perpendicularly backwardly extended from a back wall of an opposite lateral side of the face panel frame 12 and respectively disposed adjacent to opposing top and bottom sides of the face panel frame 12, a front cover panel 16 pivotally coupled to the sliding rails 15 for closing the access opening 120 of the face panel frame 12 and movable forward and backward along the sliding rails 15, an accommodation chamber 10 surrounded by the upright panels 17, the top cover panel 19 and the front cover panel 16, two sets of sliding members 102 symmetrically defined at two opposite lateral sides and at different elevations within the accommodation chamber 10, a plurality of partition boards 13 detachably and selectively inserted into the sliding members 102 and defining an insertion slot 130 between each two adjacent partition boards 13, a compartment 101 defined in between one upright panel 17 and the associating peripheral cover panel 18, and an upright plate 14 mounted at a front side of the compartment 101 and defining a plurality of insertion holes 140 corresponding to the plug holes 121 and indicator mounting holes 122 of the face panel frame 12, Further, each partition board 13 has a front notch 131 located at a front side thereof at the center. Further, each peripheral cover panel 18 defines a plurality of ventilation holes 180. Further, an adapter hole 181 is formed in the peripheral cover panel 18 that is disposed at the back side of the base frame 11 opposite to the face panel frame 12. Further, a recessed handhold 182 is formed in each of the two peripheral cover panels 18 that are disposed at the two opposite lateral sides of the base frame 11.

The power module 2 comprises a control system 21, a system circuit board 22, and a power adapter 23. The control system 21 is electrically coupled with the system circuit board 22 and the adapter 23, comprising a circuit layout (not shown) for processing electronic signals, and a built-in power source (dry battery cell, rechargeable battery, storage battery, lithium-ion battery, etc., adapted to provide the power module 2 with the necessary electrical energy for working). The system circuit board 22 carries therein a circuit layout (not shown), comprising a plurality of electrical connectors 221, and a plurality of indicator lights 222 respectively electrically connected to the electrical connectors 221 for indicating the operation status of the electrical connectors 221. The power adapter 23 can be made in the form of a power adapter plug or power adapter socket electrically connectable to an external power source (city power supply or power generator) to provide the power module 2 with the necessary electrical energy for working.

During installation, partition boards 13 are selectively inserted into the sliding members 102 so that different sizes of insertion slots 130 can be respectively defined between each two adjacent partition boards 13. Further, the power module 2 is mounted at the base frame 11 in the bottom side of the accommodation chamber 10, enabling the control system 21 and system circuit board 22 of the power module 2 to be positioned in the compartment 101 between one upright panel 17 and the associating peripheral cover panel 18 in such a manner that the electrical connectors 221 and indicator lights 222 of the system circuit board 22 are respectively inserted through the insertion holes 140 of the upright plate 14 into the plug holes 121 and indicator mounting holes 122 of the face panel frame 12, and the power adapter 23 to be positioned in the adapter hole 181 in the peripheral cover panel 18 that is disposed at the back side of the base frame 11.

Further, the two sets of sliding members 102 of the housing 1 are equally spaced and symmetrically defined at two opposite lateral sides and at different elevations within the accommodation chamber 10. In one embodiment, the sliding members 102 are sliding rails. In another embodiment, the sliding members 102 are sliding grooves. Thus, the user can selectively insert partition boards 13 into the sliding members 102 to adjust the height of each insertion slot 130 between each two adjacent partition boards 13.

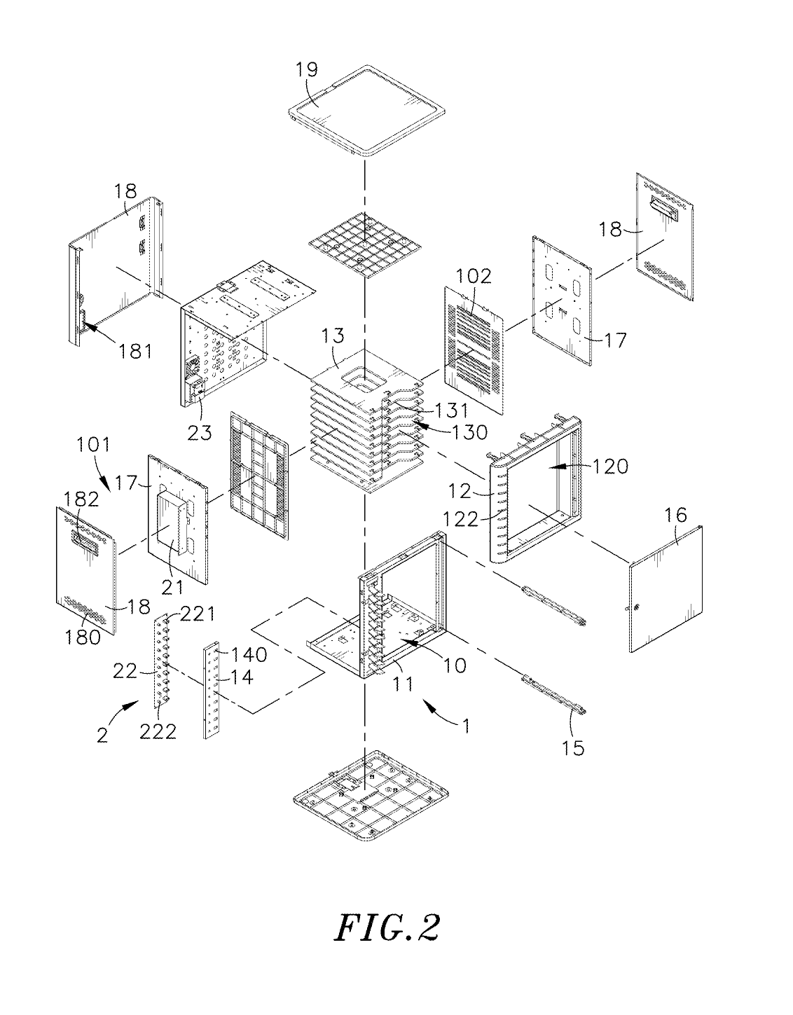

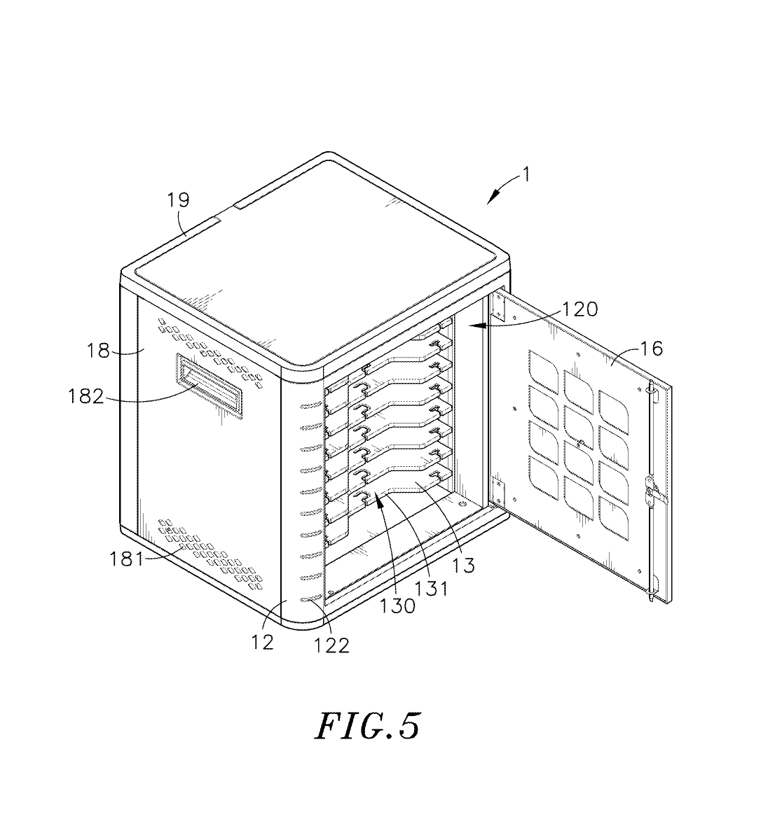

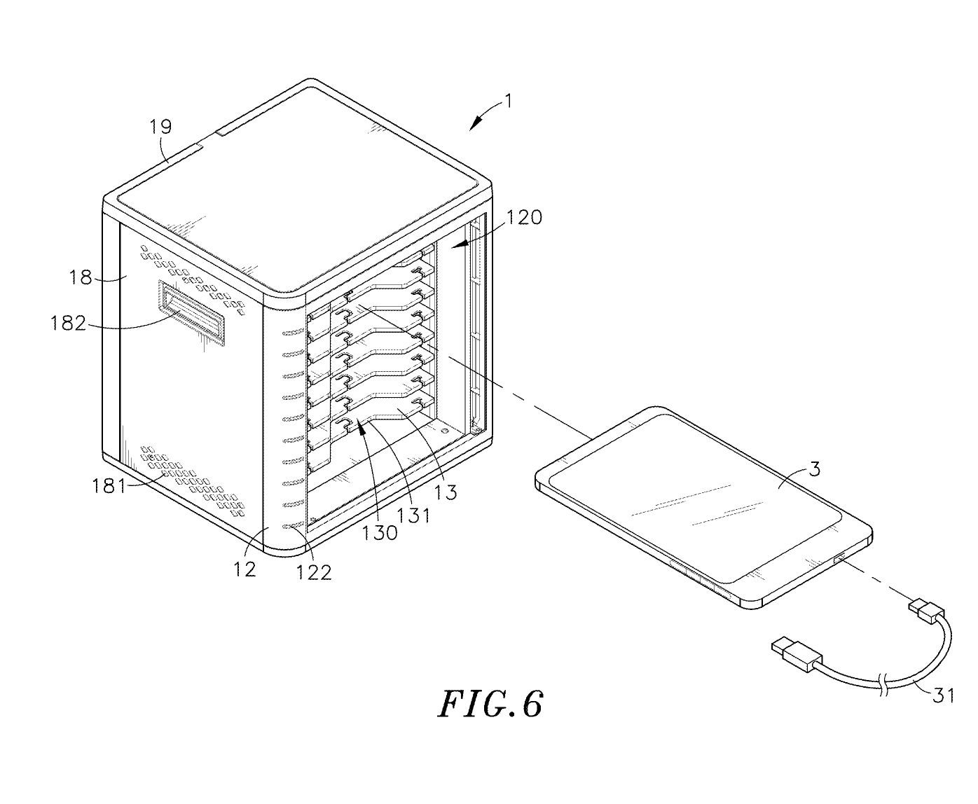

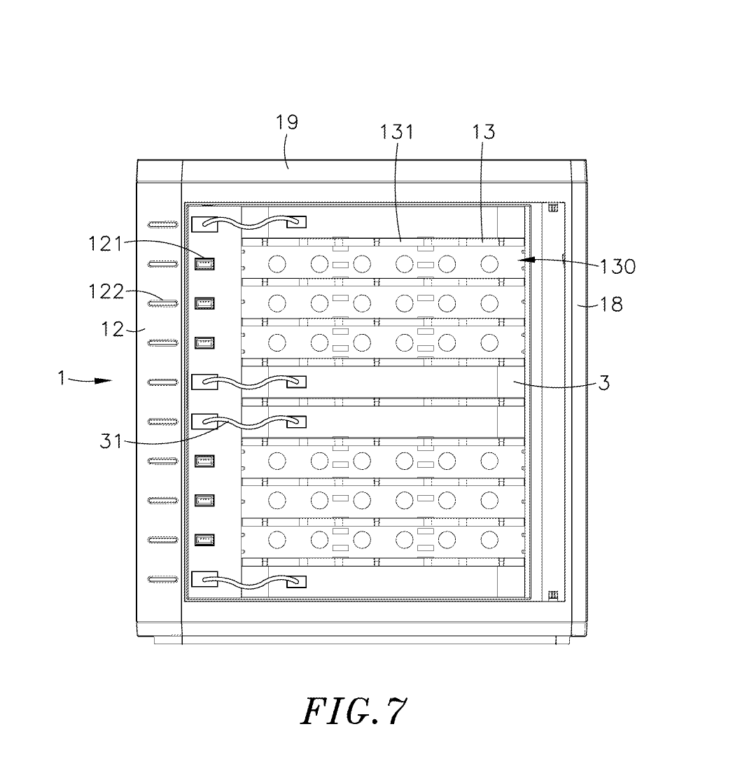

Further, the electrical connectors 221 of the system circuit board 22 of the power module 2 can be USB2.0 connectors, USB3.0 connectors, Micro USB connectors, power connectors, HDMI connectors, SATA connectors, or eSATA connectors. In addition to the function for electricity transmission, the electrical connectors 221 can also transmit electrical signals or electronic data synchronously. Referring to FIGS. 5-7 and FIGS. 2-4 again, the desk storage device can be placed on a table or platform. At this time, the user can turn the front cover panel 16 outwardly relative to the face panel frame 12 through 90° angle to open the access opening 120, and then move the front cover panel 16 backwardly along the sliding rails 15 to the inside of the accommodation chamber 10, and then insert each mobile electronic device 3 (such as tablet PC or smart phone) through the access opening 120 of the face panel frame 12 into one respectively selected insertion slot 130 between two respective adjacent partition boards 13, and then insert the transmission cable 31 of each mobile electronic device 3 through one respective plug hole 121 of the face panel frame 12 into one respective electrical connector 221 of the system circuit board 22 of the power module 2 in the respective insertion hole 140 of the upright plate 14 mounted at a front side of the compartment 101. At this time, each inserted mobile electronic device 3 is electrically charged by the power module 2 subject to the control of the control system 21. At the same time, the indicator lights 22 of the power module 2 are controlled by the control system 21 to give respective visual signals to indicate different charging conditions of each respective mobile electronic device 3 (for example, red light to indicate the status of under charging; green light to indicate the status of charge complete; yellow light to indicate the status of not used). Further, the indicator lights 22 can be full-color LEDs (light-emitting diodes) or different colors of high-brightness LEDs (light-emitting diodes) controllable to give off light or to perform different flashing modes. After one inserted mobile electronic device 3 is well charged, the control system 21 immediately controls the system circuit board 22 to cut off power supply from the respective electrical connector 221 and to reset the charging settings for the respective electrical connector 221. At this time, the user can remove every charged mobile electronic device 3 out of the respective insertion slot 130 and the access opening 120. Through the front notch 131 of each partition board 13, the user can remove each inserted mobile electronic device 3 out of the respective insertion slot 130 conveniently by hand.

Further, subject to connection between the transmission cables 31 of mobile electronic devices 3 and respective electrical connectors 221 of the system circuit board 22 of the power module 2, the mobile electronic devices 3 can be linked together for transmitting electronic signals or data therebetween directly without interference. Further, when inserted mobile electronic devices 3 are charged by the power module 2, these mobile electronic devices 3 are well protected in the respective insertion slots 130 by the partition boards 13, avoiding scratch or impact damage. Further, the design of the housing 11 and power module 2 of the desk storage device enables a large number of mobile electronic devices 3 to he charged synchronously, saving much charging time and labor.

As stated above, the invention provides a desk storage device, which comprises a housing 1, which comprises a an accommodation chamber 10, a face panel frame 12 disposed at a front side of the accommodation chamber 10 and defining a plurality of plug holes 121 and indicator mounting holes 122 at one lateral side thereof at different elevations, two sets of sliding members 102 symmetrically defined at two opposite lateral sides and at different elevations within the accommodation chamber 10 and a plurality of partition boards 13 detachably and selectively inserted into the sliding members 102 and defining an insertion slot 130 between each two adjacent partition boards 13, and a power module 2, which is mounted in the accommodation chamber 10, comprising a system circuit board 22 that comprises a plurality of electrical connectors 221 and a plurality of indicator lights 222 respectively mounted in the plug holes 121 and indicator mounting holes 122, a power adapter 23 for providing the power module 2 with the necessary working power supply and a control system 21 that controls the electrical connectors 221 to charge every mobile electronic device 3 that is inserted into one respective insertion slot 130 and electrically connected to one respective electrical connector 221 by a respective transmission cable 31 and the indicator lights 222 to give off light or to flash subject to the charging status of each respective mobile electronic device 3. By means of selectively inserting partition boards 13 into the sliding members 102, the vertical height of each insertion slot 130 between two adjacent partition boards 13 can be adjusted to fit a different mobile electronic device 3.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A desk storage device, comprising:
a housing comprising an accommodation chamber, two sets of sliding members symmetrically defined at two opposite lateral sides and at different elevations within said accommodation chamber, a plurality of partition boards detachably and selectively inserted into said sliding members and defining an insertion slot between each two adjacent said partition boards, a face panel frame disposed at a front side of said accommodation chamber, said face panel frame comprising an access opening disposed at the center thereof and a plurality of plug holes and indicator mounting holes disposed at one lateral side relative to said access opening at different elevation, and a front cover panel adapted for closing and opening said access opening of said face panel frame; and
a power module mounted in said accommodation chamber inside said housing, said power module comprising a system circuit board and a control system electrically coupled with said system circuit board, said control system comprising a circuit layout for processing electronic signals, said system circuit board comprising a plurality of electrical connectors and a plurality of indicator lights respectively mounted in said plug holes and said indicator mounting holes, said electrical connectors of said system circuit board being controllable by said control system to charge every mobile electronic device that is inserted into one respective said insertion slot and electrically connected to one respective said electrical connector by a respective transmission cable, said indicator lights being controllable by said control system to give off light and to flash subject to the charging status of each respective said mobile electronic device that is connected to one respective said electrical connector.

2. The desk storage device as claimed in claim 1, wherein said housing further comprises a base frame, a plurality of upright panels respectively mounted at two opposite lateral side and a back side of said base, frame in vertical, a peripheral cover panel affixed to each said upright panel, and a top cover panel fixedly mounted at the topmost edges of said upright panels in such a manner that said accommodation chamber is surrounded by said upright panels, said top cover panel and said front cover panel.

3. The desk storage device as claimed in claim 1, wherein each said partition board comprises a front notch located at a front side thereof.

4. The desk storage device as claimed in claim 1, wherein said housing further comprises two sliding rails perpendicularly backwardly extended from a back wall of said face panel frame and respectively disposed adjacent to opposing top and bottom sides of said face panel frame; said front cover panel is pivotally coupled to said sliding rails and movable forward and backward along said sliding rails.

5. The desk storage device as claimed in claim 1, wherein said power module further comprises a power adapter electrically connected to said control system and electrically connectable to an external power source and adapted to provide said power module with the necessary electrical energy for working; said control system comprises a built-in power source adapted to provide said power module with the necessary electrical energy for working.

6. The desk storage device as claimed in claim 5, wherein said built-in power source is selected from the group of dry battery cell, rechargeable battery, storage battery and lithium-ion battery.

7. The desk storage device as claimed in claim 5, wherein said power adapter is selectively made in the form of a power adapter plug or power adapter socket electrically connectable to city power supply or power generator to provide said power module with the necessary electrical energy for working.
